(19) United States
(12) Patent Application Publication
(10) Pub. No.: US 2021/0042563 A1
(43) Pub. Date: Feb. 11, 2021

(54) DIGITAL TECHNOLOGY OF CULTURAL RELICS, CALLIGRAPHY, PAINTING AND ORIGINAL COMMODITIES

(71) Applicant: Fenghua LIU, Guiyang (CN)

(72) Inventor: Fenghua LIU, Guiyang (CN)

(21) Appl. No.: 17/002,949

(22) Filed: Aug. 26, 2020

Related U.S. Application Data
(63) Continuation of application No. PCT/CN2019/000033, filed on Feb. 22, 2019.

(30) Foreign Application Priority Data
Feb. 26, 2018 (CN) 201810158625.9

(51) Int. Cl. G06K 9/46; G01N 21/55; G01N 21/47

(52) U.S. Cl. CPC G06K 9/4652; G01N 21/47; G01N 21/55

(57) ABSTRACT

The present invention discloses a digital technology of cultural relics, calligraphies, paintings and original commodities. All object individuals are composed of different astronomical three-dimensional atom-molecular clusters. The non-visible light electromagnetic waves of the characteristic wavelengths or bands in the wavelength range of 30 μm-100 Mm, which can cause sensitive electromagnetic interactions with the nucleon-electron clusters of various kinds of objects, can be adopted to irradiate object individuals or part of object individual and extract reflected waves and scattered waves of millions or tens of millions of electromagnetic space units at single or multiple interface depths, and the light intensity distributions of extracted reflected waves and scattered waves can be converted to individual-specific identity identification digital matrix codes through analog-digital conversion. The present invention can realize the specific identity identification of various kinds of object individuals.

### CROSS-REFERENCE TO RELATED APPLICATIONS

This application is a continuation of International Patent Application No. PCT/CN2019/000033, filed on Feb. 22, 2019, which claims the benefit of priority from Chinese Patent Application No. 201810158625.9, filed on Feb. 26, 2018. The content of the aforementioned applications, including any intervening amendments thereto, is incorporated herein by reference.

### TECHNICAL FIELD

A claimed technical solution belongs to the field of object identification.

### BACKGROUND OF THE PRESENT INVENTION

When irradiating objects, visible light electromagnetic waves may produce physical phenomena such as reflection, scattering, refraction, absorption, transmission and diffraction, reflected waves and scattered waves of the visible light are generally used to extract color feature information of the object surface. The data cluster generated by the analog-digital conversion of reflected waves and scattered waves can represent color features of the object surface. Therefore, the visible light reflected wave and scattered wave technology can technically digitalize the color features of the object surface.

### SUMMARY OF THE PRESENT INVENTION

The digitalization of three-dimensional exterior-interior electromagnetic structure characteristics of objects such as cultural relics, calligraphies, paintings, and original commodities is a technical problem to be solved by the present invention. Pottery, jade, bronze and other cultural relics inherit history, culture, aesthetics, emotion, custom, craft, technology, science, worship and belief of country, ethnic and society, most of the precious cultural relics that have existed for thousands of years are provided for visitors in museums and historical sites. Some cultural relics can become private collections through commercial transactions. The handmade cultural relics are different from each other theoretically, and the cultural relics which locate in different physical-biochemical spaces and change with time are different at the atom-molecular levels. Calligraphy, ink painting, oil painting, carving, sculpture and other artworks show rich and colorful personalities due to creative elements such as authors, materials, techniques, styles, appearances and artistic conceptions. Some famous works handed down from ancient times have caused some sensations in the world art auctions because of sky-high-priced commercial transactions of tens of millions dollars. The masterpieces can be counterfeited by simulating materials, techniques, brightnesses, shades and colors to realize the surface similarity and spirit similarity, but it is impossible to realize the counterfeiting at the three-dimensional exterior-interior atom-molecular levels. The annual trading volume of object commodities such as agricultural products and industrial products in the world is in the unit of ten billions. Due to the differences in labor, raw materials, production processes and manufacture technologies, each object commodity is different at the atom-molecular levels. According to the technical solution of the present invention, the electromagnetic waves with longer wavelength comparing with visible light are used to irradiate objects such as cultural relics, calligraphies, paintings and original commodities to obtain reflected waves and scattered waves as electromagnetic wave identification information of representing three-dimensional exterior-interior structure characteristics. Although pottery, jade, bronze, calligraphy, ink painting, oil painting, carving, sculpture, agricultural product, industrial product, vehicle, ship, submarine, aircraft, mountain, volcano, river, sea, lake, bridge and building are diverse in colors and shapes, but all object individuals are composed of different astronomical atom-molecular clusters. All kinds of atoms and molecules are different nucleon-electron spin-circulation electromagnetic microunits, and the three-dimensional assembly of massive electromagnetic microunits with different properties, quantities and distributions can determine the different electromagnetic structures of any object individuals. The nucleon and electron particles as free charges and bound charges of atom-molecule clusters which can interact with electric fields are different in properties, quantities and distributions of the three-dimensional atom-molecular clusters of any object individuals. The magnetic fields interaction media of diamagnetic, paramagnetic, ferromagnetic, ferrimagnetic and antiferromagnetic atom-molecule clusters determined by electron orbital magnetic moments and nucleon-electron spin magnetic moments are different in properties, quantities and distributions of the three-dimensional atom-molecular clusters of any object individuals. The electromagnetic coefficients such as electrical conductivity σ, relative dielectric constant εᵣ and magnetic susceptibility χₘ related to the nucleon-electron clusters of various materials are different from each other. The linear equations such as J_{c}=σE, D=εᵣε₀E and M=χₘH show that different electromagnetic coefficients lead to different electromagnetic energy transformation efficiencies. When the specific frequencies of the electromagnetic waves in the band of 30 μm-100 million meters are equal to or approximate to the intrinsic electromagnetic frequencies of the nucleon-electron clusters of the object individual, the electromagnetic interactions of the specific frequencies may lead to various changes of nucleon-electron electromagnetic energy such as conduction, magnetization, polarization, rotation or vibration. Meanwhile, the energy transformation efficiencies of electromagnetic interactions are different from each other due to the different electromagnetic coefficients such as electrical conductivity σ, relative dielectric constant εᵣ and magnetic susceptibility χₘ, so the spectrum characteristics manifested by the interactions of the different nucleon-electron clusters of any object individuals with the non-visible light electromagnetic waves in the wavelength range of 30 μm-100 million meters are also different from each other. The cultural relics, calligraphies, paintings and original commodities can be made of the materials of insulators, semiconductors or conductors, and the penetration depths of electromagnetic waves with different wavelengths to the materials with different electric conductivity σ are different. The reflected waves, scattered waves, refracted waves, absorbed waves, transmitted waves or diffracted waves obtained by irradiating object individuals or parts of object individuals with electromagnetic waves in the wavelength range of 30 μm-100 million meters covering terahertz waves, millimeter waves, centimeter waves, decimeter waves, meter waves, radio frequency waves and low frequency waves can represent the nucleon-electron electromagnetic structure characteristics of astronomical atom-molecular clusters and realize individual identity identification. At present, the commonly used object identity identification technologies include eye identification, photo, signature, seal, trademark and bar code, which are dependent on color images of the visible light. According to the reflected wave theory, the electromagnetic information extraction depth of the reflected waves and scattered waves of the visible light at the object interface is less than 750 nm due to the restriction of the 350 nm-750 nm wavelength range. The electromagnetic information extraction depth of the electromagnetic waves within the wavelength range of 30 μm-100 million meters at the object interface is remarkably deeper than that of the visible light because of the longer wavelength. For the object individuals composed of the insulator, semiconductor or conductor, the present invention can utilize the electromagnetic waves of non-visible light in the wavelength range of 30 μm-100 million meters to extract the reflected waves and scattered waves of representing the three-dimensional exterior-interior electromagnetic structure characteristics as the identity identification information. The counterfeiting of the surface colors of an object original is technically feasible and low in cost, but the counterfeiting of the electromagnetic structure of three-dimensional exterior-interior atom-molecular clusters of an object original is technically impossible, no matter how much it costs. The present invention can extract the reflected waves and scattered waves of representing the three-dimensional exterior-interior electromagnetic structure characteristics to serve as the identity identification digital codes after the analog-digital conversion, the fakes of cultural relics, calligraphies, paintings and original commodities are impossible to be sold out any more. Therefore, comparing with the eye identification, photo, signature, seal, trademark and bar code depending on the visible light, the present invention is technically advanced obviously.

### DETAILED DESCRIPTION OF THE PRESENT INVENTION

The information extraction depth of reflected waves and scattered waves of visible light in the band of 350 nm-750 nm at the object interface is less than 750 nm due to the restriction of wavelength range. Meanwhile, the visible light is usually limited to the representation of color information, so the interface information extracted by the identification technology of visible light photography is essentially surface color data, regardless of the millions or tens of millions of pixel sensors used. The wavelength scale of non-visible light electromagnetic wave in the band of 30 μm-100 million meters is expanded by more than 10¹² exponential orders. Comparing with the visible light, the wavelength of electromagnetic wave in the band of 30 μm-100 million meters is longer, so the electromagnetic band can interact with the nucleon-electron clusters which are composed of about one hundred kinds of element units at various depths of the object interface. The equation E=hc/λ shows the inverse relation between the electromagnetic wave energy and the wavelength. Following with the change of energy, the electromagnetic waves in the band of 30 μm-100 million meters can cause strong or weak electromagnetic interactions such as vibration, rotation, polarization, magnetization and conduction with the nucleon-electron electromagnetic media. When the specific frequencies of the electromagnetic waves in the band of 30 μm-100 million meters are equal to or approximate to the intrinsic electromagnetic frequencies of various nucleon-electron clusters of the object, the electromagnetic interactions can happen at the specific frequencies. However, the magnitudes of electromagnetic interactions at the specific frequencies can be different due to different electromagnetic coefficients such as conductivity σ, relative dielectric constant εᵣ and magnetic susceptibility χₘ of various materials. Therefore, in theory, the electromagnetic wave in the band of 30 μm-100 million meters can be used as the detection light source to irradiate the object interface and extract the characteristic reflected waves, scattered waves, refracted waves, absorbed waves, transmitted waves or diffracted waves which can represent electromagnetic structure characteristics of various properties, quantities and distributions of the object nucleon-electron clusters. Since the electromagnetic structure characteristics of properties, quantities and distributions of nucleon-electron clusters of the object individuals are different from each other, the spectrum characteristics of reflected waves, scattered waves, refracted waves, absorbed waves, transmitted waves or diffracted waves of the object individuals extracted by the electromagnetic waves in the wavelength range of 30 μm-100 million meters as the detection light sources are different from each other. In practical applications, the reflected waves and scattered waves are usually used as individual-specific electromagnetic information. The electromagnetic wave information can be converted into digital information by analog-digital conversion in order to digitalize three-dimensional exterior-interior electromagnetic structure characteristics, and the comparison of digital information of the object individuals can realize the identity identification of any object individuals; The electromagnetic waves in the band of 30 μm-100 million meters include terahertz waves, millimeter waves, centimeter waves, decimeter waves, meter waves, radio frequency waves and low frequency waves. Some advanced technologies can be adopted to provide a series of instrument systems to cover the incident light sources and photo detectors in each waveband. On the basis of selected parameters such as distance, azimuth angle, elevation angle and sampling gate width, the incident light source of each band can be applied to scan the specific kind of object and then the overall light intensity of incident waves, transmitted waves or reflected waves and scattered waves can be measured. The absorbance can be calculated by the logarithm calculation of overall light intensities of incident waves and transmitted waves. The characteristic spectrum curve of specific object category in each waveband can be obtained by the plotting of absorbance or overall light intensity of the reflected waves and scattered waves against the wavelength. The wavelengths corresponding to the highest points of the absorbance crests or the lowest points of light intensity troughs of the reflected waves and scattered waves can be the sensitive wavelengths with the strongest interaction at certain bands. The number of sensitive wavelengths can be determined by the number of light intensity troughs or absorbance crests. The surface units and detection depth can be combined to form electromagnetic space units. The light intensity space distribution of reflected waves and scattered waves in millions or tens of millions of electromagnetic space units is the optical basis of interface exterior-interior identification of the present invention. The current or particularly developed optical sensors at the sensitive wavelengths or bands, which may be integrated with millions or tens of millions of pixel sensor chips, can be used to measure the light intensity of the reflected waves and scattered waves at the object individual surface and obtain light intensity distribution matrix with millions or tens of millions of pixels, which can represent the structure characteristics of millions or tens of millions of the object interface exterior-interior electromagnetic space units. Because of the electromagnetic structure differences corresponding to properties, quantities and distributions of astronomical nucleon-electron clusters in millions or tens of millions of electromagnetic space units of the detection space, individual identity identification of specific object category can be theoretically realized by the detection light with a single sensitive wavelength. In practical applications, it can be decided by experiments to adopt single, two or more sensitive wavelengths or narrow bands or wide bands covering sensitive wavelengths as the detection light sources to represent the electromagnetic structure differences to the maximum extent in order to realize better individual identification. For any kinds of objects, the characteristic sensitive wavelengths or sensitive bands can be determined by the full-band scanning method, and then the sensitive wavelengths or bands can be used as the detection light sources to extract the light intensity distribution data matrices of reflect waves and scattered waves of millions or tens of millions of electromagnetic space units at various interface depths, and then the object classification and individual identification can be realized by comparing the similarities and differences of light intensity distribution data matrices of reflect waves and scattered waves of millions or tens of millions of electromagnetic space units measured by millions or tens of millions of pixel sensor chip matrices. Because of the complexities of various electromagnets such as linear and nonlinear electromagnets, homogeneous and non-homogeneous electromagnets, isotropic and non-isotropic electromagnets, only by determining the standard working parameters such as power, distance, azimuth angle, elevation angle, wavelength, band, polarization, pulse time width and sampling gate width can the accuracy, reliability and repeatability of data be ensured. The non-visible light intensity distribution of the reflected waves and scattered waves of all kinds of object individuals can be extracted by the standardized method. The electromagnetic wave intensities can be converted into digital signals by the analog-digital conversion technology. The electromagnetic wave with sensitive wavelength can be adopted to extract the light intensity distribution data matrix code of millions or tens of millions of electromagnetic space units at the specific depth. The electromagnetic waves in sensitive band can be adopted to extract light intensity distribution data matrix block of millions or tens of millions of electromagnetic space units at continuous depths, and several light intensity distribution data matrices at a few separate wavelengths of the sensitive bands can be selected as identity identification digital matrix code series. Therefore, the characteristic sensitive wavelengths or bands can be used as detection light to extract the light intensity distribution data matrices of the reflected waves and scattered waves of millions or tens of millions of electromagnetic space units, and by the present invention any object individuals can be transformed to a single data matrix code or multiple data matrix codes, the individual-specific matrix codes are different from each other and can be used in the digital management such as storage, transmission, calculation, comparison, identification and statistics. The standard working parameters can be selected in a three-dimensional coordinate system, single, two or more sensitive wavelengths or narrow or wide sensitive bands in the wavelength range of 30 μm-100 million meters can be used as the detection waves to irradiate the object originals or parts of the object originals to extract light intensity distribution matrices of the reflected waves and scattered waves which can be converted to identity identification digital matrix codes. The identity identification database of target objects such as cultural relics, calligraphies, paintings and original commodities can be established according to the requirements of National Standardization Administration of China and International Organization of Standardization. The annual transaction amount of the object commodities such as cultural relics, calligraphies, paintings and original commodities in the global stores and internet commerce is in the unit of ten billions. The rampant fakes substantially harm the interests of original authors, producers, brands and consumers, and in the meantime the fakes ruin the original spirit of society, honest labor and mutual trust in transactions. However, it is impossible to technically realize atom-molecular clusters of the fakes to be the same in properties, quantities and distributions as the atom-molecular clusters of object originals at any cost. The electromagnetic waves in the wavelength range of 30 μm-100 million meters can be used to irradiate the object individuals, and the extracted reflected waves and scattered waves can digitalize the nucleon-electron electromagnetic structure characteristics of the atom-molecular clusters. The identity identification digital matrix codes of reflected waves and scattered waves can fully expose the fakes and make the fake trades impossible. The identity identification digital matrix codes representing the irreproducible electromagnetic structure characteristics of the three-dimensional exterior-interior atom-molecular clusters may accelerate the commercial transactions of the medium-end, medium-high-end and high-end object originals. On the premise of ensuring the accuracy, authority and safety of the identity identification digital matrix codes of the object individuals, consumers can use mobile phones to transmit the identity identification digital matrix codes of commodities and compare the digital matrix codes among the independent producer, national standard databases and international standard databases in a few seconds to confirm whether the product is the genuine product original. In the time of rapid digital economy development, the identity identification digital matrix code proposed by the present invention can provide fundamental technical support for the object transactions. The electromagnetic waves in corresponding sensitive wavelengths or bands of 30 μm-100 million meters range can be adopted at the sites of indoor, land, ocean, sky and space to irradiate various targets such as cultural relics, artworks, vehicles, ships, submarines, aircrafts, mountains, volcanoes, rivers, seas, lakes, bridges and buildings and extract the reflected waves and scattered waves for representing the three-dimensional exterior-interior electromagnetic structure characteristics which can be converted to identity identification digital matrix codes through analog-digital conversion. The identification technology of visible light in the band of 350 nm-750 nm is seriously interfered by rain, snow and fog due to the wavelength, while the electromagnetic waves of non-visible light in the band of 30 μm-100 million meters can be better resistant to rain, snow and fog due to the longer wavelength and identify the targets under any weather conditions. Through the integrated application of the electromagnetic waves, sensors, internets, computer clusters, softwares, cloud computing, artificial intelligence, mobile phones and human intelligence, the present invention can automatically identify important targets in sea, land and air and can be applied to positioning, speed measurement, early warning and other tasks.

We claim:

1. A digital technology of cultural relics, calligraphy, painting, and original commodities, the closest current technology is the identification technology of visible light photography; and the common feature of the present invention and the identification technology of visible light photography is using electromagnetic waves which travel approximately at the light speed in the air as detection tools; wherein the object information extracted by the identification technology of visible light photography is the surface color data cluster, and the identification technology of visible light photography in the wavelength range of 350 nm-750 nm is seriously interfered by rain, snow and fog due to the wavelength; although pottery, jade, bronze, calligraphy, ink painting, oil painting, carving, sculpture, agricultural product, industrial product, vehicle, ship, aircraft, mountain, river, sea, bridge, building and other objects are diverse in colors and shapes, but all objects are different astronomical three-dimensional exterior-interior atom-molecular clusters; all kinds of atoms and molecules are different nucleon-electron spin-circulation electromagnetic microunits; and the three-dimensional assembly of massive electromagnetic microunits with different properties, quantities and distributions can determine the differences of electromagnetic structures of any object individuals; the electromagnetic coefficients such as electrical conductivity σ, relative dielectric constant εᵣ and magnetic susceptibility χₘ related to the nucleon-electron clusters of various materials are different from each other; the linear equations such as J_{c}=σE, D=εᵣε₀E and M=χₘH show that different electromagnetic coefficients lead to different electromagnetic energy transformation efficiencies; the non-visible electromagnetic waves in the wavelength range of 30 μm-100 million meters can irradiate atom-molecular clusters and cause various strong or weak electromagnetic interactions with nucleon-electron particles such as vibration, rotation, polarization, magnetization or conduction at different frequencies; in the meantime, the change of electromagnetic energy is related to the electromagnetic coefficients such as conductivity σ, relative dielectric constant εᵣ and magnetic susceptibility χₘ of materials; therefore, the spectrum characteristics manifested by the interaction between different atom-molecular electromagnetic microunit clusters of any object individuals and electromagnetic waves in the wavelength range of 30 μm-100 million meters are different from each other; the characteristic sensitive wavelength or band of interaction between the non-visible light electromagnetic band and the nucleon-electron electromagnetic cluster can be determined by the characteristic trough or crest of spectrum; the light intensity distribution matrices of reflected waves and scattered waves of millions or tens of millions of electromagnetic space units at single or multiple interface depths can be extracted by applying sensitive wavelength or band detection waves to irradiate the object individuals; the light intensity distribution matrix of the reflected waves and scattered waves can be converted to an individual-specific identity identification digital matrix code through analog-digital conversion; according to the reflected wave theory, because of the wavelength limitation of the visible light in the band of 350 nm-750 nm, the reflected waves and scattered waves at interfaces can only extract the visible color data of red, orange, yellow, green, cyan, blue and violet colors at less than 750 nm depth, while the electromagnetic band which wavelengths expand from micron to one hundred megameter theoretically can extract the three-dimensional exterior-interior electromagnetic data of non-visible light property covering part or whole of electromagnetic media of the object individuals at various depths from surface to the depth of less than one hundred megameter; the electromagnetic information extraction depth of the electromagnetic waves in the wavelength range of 30 μm-100 million meters at the object interface is apparently deeper than that of the visible light due to the longer wavelength; in the meantime, because of the longer wavelength, the electromagnetic waves in the wavelength range of 30 μm-100 million meters with better resistance to rain, snow and fog can extract the electromagnetic structure characteristic information for identification under any weather conditions; it is technically feasible to realize the realistic fakes of the surface colors of the object originals at relatively low cost, while it is technically impossible to realize the fakes of the electromagnetic structures of the three-dimensional exterior-interior atom-molecular clusters of the object originals at any cost; the reliability of object identification of the present invention is far beyond the identification technology of visible light photography due to different wavelengths, therefore, comparing with the current identification technology of visible light photography the advantage of the present invention is remarkable, and different from the identification technology of visible light photography, the advanced technology characteristics of the present invention, such as three-dimensional exterior-interior penetration detection capability, individual-specific identity identification digital matrix code, resistance to rain, snow and fog interference and high reliability, are based on the physical, chemical and electromagnetic science theories; and because the spectrum characteristics manifested by irradiating the astronomical three-dimensional atom-molecular clusters of any object individuals with non-visible light in the wavelength range of 30 um-100 million meters are different from each other, and in the meantime, the electromagnetic waves with characteristic wavelengths or bands related to crests of absorbance spectra or troughs of reflected waves and scattered waves spectra, which can match intrinsic electromagnetic frequencies of nucleon-electron clusters, can be used to irradiate millions or tens of millions of the interface exterior-interior electromagnetic space units, and the extracted light intensity distribution matrices of reflected waves and scattered waves of any object individuals are different from each other, therefore, the technical scope claimed by the present invention is to irradiate the object individuals or part of the object individual by using the electromagnetic waves of single wavelength, two wavelengths or more wavelengths or narrow band or broad band in the wavelength range of 30 μm-100 million meters, which can represent the differences of the three-dimensional exterior-interior nucleon-electron electromagnetic structures of various kinds of object individuals through electromagnetic interactions, and to immediately extract reflected waves, scattered waves, refracted waves, absorbed waves, transmitted waves or diffracted waves which can be used as the object-individual-specific electromagnetic waves identity identification information.
